(19) United States
(12) Patent Application Publication
(10) Pub. No.: US 2003/0147251 A1
(43) Pub. Date: Aug. 7, 2003

(54) Long remaining illuminant source transforming wavelength

(75) Inventor: Chu Peng Chung, San Chong City (TW)

Correspondence Address: BACON & THOMAS, PLLC, 625 SLATERS LANE, FOURTH FLOOR, ALEXANDRIA, VA, 22314

(73) Assignee: Chye-Tay Co., Ltd., Taipei (TW)

(21) Appl. No.: 10/066,772

(22) Filed: Feb. 6, 2002

(51) Int. Cl. F21V 17/02

(52) U.S. Cl. 362/512

(57) ABSTRACT

Long remaining illuminant source transforming wavelength including illuminant absorption color powder and InGaN ultraviolet emission chip. The invention is presented in form of container modeling, which is made from plastic colophonium (for example epoxy resin, acrylic resin and silica gel.) and illuminant absorption color powder. The container is fitted with an InGaN ultraviolet emission chip that contains DC power source connection. The illuminant absorption container made of illuminant absorption color powder and transparent or semitransparent colophonium is with the build-in InGaN ultraviolet emission chip connecting to the power source enables the material color powder to absorb and liberate the illuminant constantly. Hence to deliver a brighter, clearer and long lasting lame illuminant. In addition, lame illuminant is delivered in flat form hence enhance the conduct and glowing of illuminant. Furthermore, such lame illuminant can also be used for other industrial purposes; for example, it can be applied to various types of plastics or transferred through presswork, printing and spraying as the interface materials of various stationary, toy, glass, china and safety indicator. Therefore, the present invention can be widely used to fit the industrial needs, hence an effective innovation.

### BACKGROUND OF THE INVENTION

The present invention is related to “long remaining illuminant source transforming wavelength”. The “long remaining illuminant source transforming wavelength” which extents the timing of conducting and glowing illuminant. The illuminant absorption color powder absorbs and liberates the illuminant, absorbing ultraviolet illuminant wavelength 200 nM˜450 nM) and liberating into human sight conduct limit (wavelength 450 nM˜650 nM). The InGaN ultraviolet emission chip is supported with DC power source (3.5V to 4.5V), enable the illuminant absorption color powder absorbs and liberates the illuminant continually, enhance the conduct and glowing of the illuminant and keeps lame illuminant last longer.

Traditional illuminant absorption units are usually not innovative, although they take the same effects of absorbing and liberating illuminant. For this reason, they are usually to be made in different kind of forms, design and shapes with different logo, for example, ornaments, animal shape toys, key rings and adornments in order to attract general public in the market place. Raw materials of such illuminant absorption unit are usually the mixture of resin and illuminant absorption powder. These raw materials are then processed to from their expected forms, designs, and shapes. These illuminant absorption units will absorb illuminant under lights then deliberate it hence glow in the dark.

Accordingly, traditional illuminant absorption units do not fit the innovative designs. Despite some people intended to diver the interface designs or transfer them to different 3-D shapes in order to attract the general public in the market place, these efforts could be merely nothing as they don't satisfy customers' needs, nor industrial needs with simply changing of the interface designs or shapes. Hence, these traditional illuminant absorption units are dull and unmeaning due to the luck of diversity.

Furthermore, the traditional illuminant absorption units usually conglomerated with illuminant absorption powder only, illuminant cannot be absorbed fully again after been liberated as the illuminant was not able to be liberated completely. Hence the lame illuminant can only last for a limited time period, consider not defective and efficient enough.

The commercial design is “long remaining illuminant source transforming wavelength” including illuminant absorption powder allow absorbing and liberating the illuminant and plastic colophonium (for example, epoxy resin, acrylic resin and silica gel.), together with build-in InGaN ultraviolet emission chip to form a 3-D illuminant container or mix the illuminant absorption powder with light reflective sheet film and chip light guide plate. The lame illuminant is delivered by the InGaN ultraviolet emission chip in flat form, the illuminant absorption unit is supported by ultraviolet, which enable the conduct and glow of the illuminant, and keep the lame illuminant last longer.

The present invention is related to “long remaining illuminant source transforming wavelength” including illuminant absorption powder. The illuminant absorption powder is a long lasting color powder; for example, S_{R}AL₂O₄:E_{U}, D_{Y} or S_{R}AL₁₄O₂₅:E_{U}, D_{Y}. The characteristic of such powder last longer hour after absorbed illuminant, hence able to liberate lame illuminant after discharged with the power supply.

The other purpose of present invention is to offer a “long remaining illuminant source transforming wavelength”. The unit is made by illuminant absorption color powder and plastic colophonium with a build-in InGaN ultraviolet emission chip. The unit will be glowing once the InGaN ultraviolet emission chip connected to DC power source. The virtue points of the unit are power-save and no hit will be produced as the required DC power source is only between 3.5V and 4,5V and is below 30 mA).

The present invention can be best understood through the following description and accompanying drawings wherein:

### BRIEF DESCRIPTION OF THE DRAWINGS

FIG. 1 is a perspective view of the present invention;

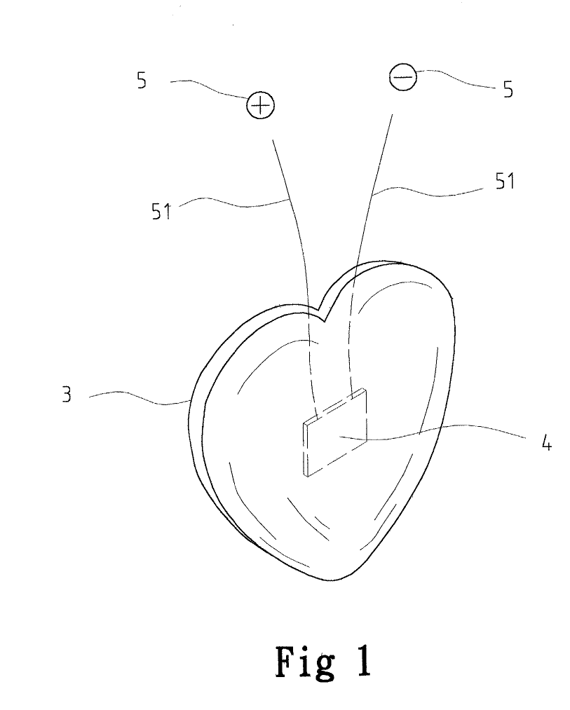

FIG. 2 is an embodiment of the present invention;

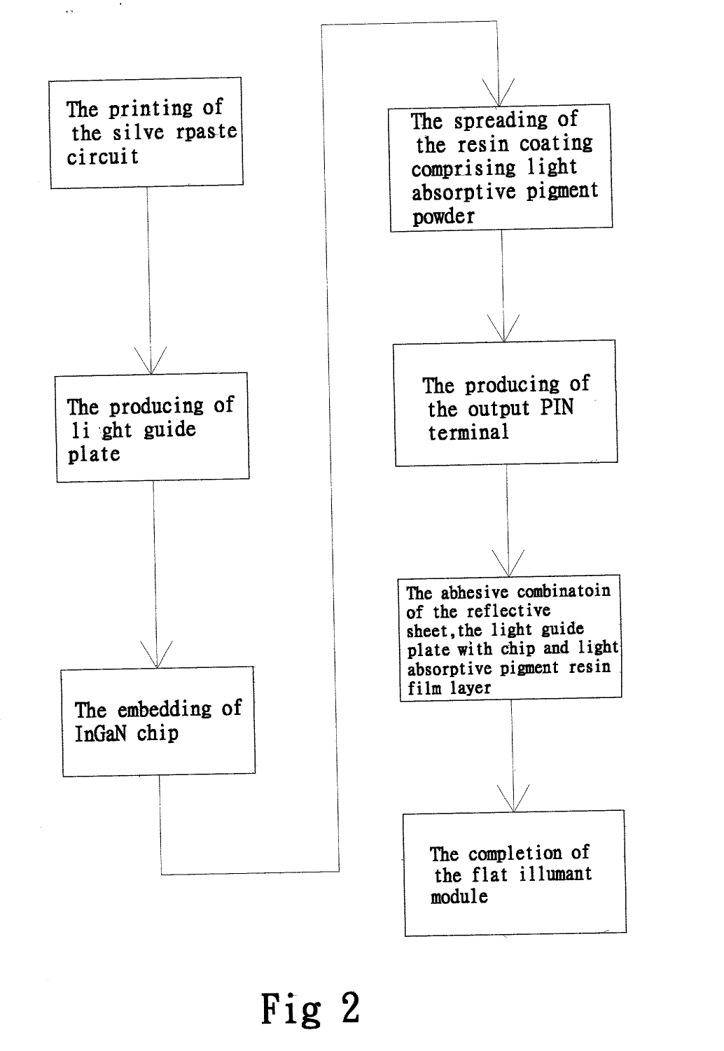

FIG. 3 shows the diagram of the printing of silver paste circuit;

FIG. 4 shows the diagram of the producing of the light guide plate;

FIG. 5 shows the diagram of the embedding of the ultraviolet emission chip;

FIG. 6 shows the diagram of the spreading of the resin coating comprising light absorptive pigment powder;

FIG. 7 shows the application of the present invention in the producing of the output PIN terminal;

FIG. 8 shows the application of the present invention in the completion of the flat illuminant module;

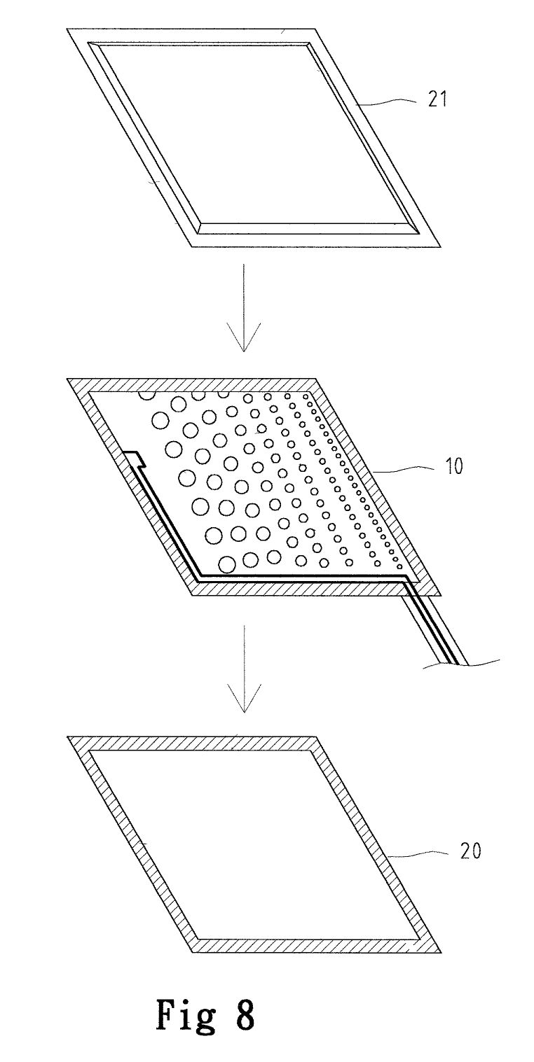

### DETAILED DESCRIPTION OF THE PREFERRED EMBODIMENTS

The present invention is related to “long remaining illuminant source transforming wavelength” of the present invention includes illuminant absorption color powder(1), plastic colophonium(2), container modeling(3), InGaN ultraviolet emission chip(4), and power source(5).

The illuminant absorption color powder (1) includes long lasting illuminant absorption color powder and ordinary illuminant absorption color powder. The characteristic of the long lasting illuminant absorption color powder is to liberate illuminant in longer hour than ordinary illuminant absorption color powder after absorbed illuminant fully. Thus, the preferable material in applying to present invention would be long lasting illuminant absorption color powder. The plastic colophonium(2), is used for cohesion purpose in present invention. The type colophonium to choose from includes the following: ABS, PC, PE, PP, PU, epoxy resin, acrylic resin, silica gel and rubber. The container modeling (3), includes any container modeling which is made from either rubber, resin, acrylic, glass or china. The transparent or semitransparent type of colophonium is preferable to form such container in order to show highest quality of brightness when liberating illuminant. InGaN ultraviolet emission chip (4), which allows ultraviolet wavelength of 395 nM˜405 nM. Normal violet ray would be allowed when apply to present invention. Power source (5), DC power source is adopted and the voltage limits are between 3.5V and 4.5V.

### SUMMARY OF THE INVENTION

It is therefore the primary object of present invention to provide the above “long remaining lighting source transforming wavelength”. The application and the effects of present invention can be best understood through the following description.

The application of “long remaining illuminant source transforming wavelength” includes two parts; 3-D illuminant and flat illuminant. It is suggested to transfer into different type of forms after processed with 3-D illuminant.

(A) 3-D Illuminant:

As in this type, a rubber processing machine will be used as a processing facility, hence to process the plastic colophonium which contain illuminant absorption color powder (1) to form any container modeling (3). InGaN ultraviolet emission chip (4) is built within the container hence conduce the diode bearing n and p poles (51) outside the container modeling (3), electricity supply is then conducted to support the present invention.

Fully compressed container type, such container was made from the ready model sets. These model sets include metal made, silica gel made, gypsum made and resin made. The container modeling was then inserted with the mixture of illuminant absorption color powder and plastic colophonium, and with the build-in InGaN ultraviolet emission chip. InGaN ultraviolet emission chip conducts with diode bearing n and p poles (51), which enable the direct connection of the power source(5).

Regarding the interface painted container type, these containers are printed or sprayed through presswork and covered with the mixture of illuminant absorption color powder and plastic colophonium (e.g. alkyd resin, nitrocellulose resin, acrylic resin, unsaturated polyester resin, polyethylcarbamate resin, polyethylcarbamate resin, polyvinyl butyral resin, polyvinyl acetate resin, rubber resin, silica gel resin, epoxy resin . . . ect). These containers of this type are either partially or fully hollow hence allowed a build-in InGaN ultraviolet emission chip to be placed within and the InGaN ultraviolet emission chip conducts with the diode bearing n and p poles (51), which enable the direct connection of the power source(5).

(B) Flat Illuminant:

In this type, the following are included; a) the printing of silver paste circuit, b) the producing of the light guide plate, c) the embedding of the ultraviolet emission chip, d) the spreading of the resin coating comprising light absorptive pigment powder, e) the producing of the output PIN terminal, f) the adhesive combination of the reflective sheet, the light guide plate with chip and light absorptive pigment resin film layer, and g) the completion of the flat illuminant module. They are described respectively as followings:

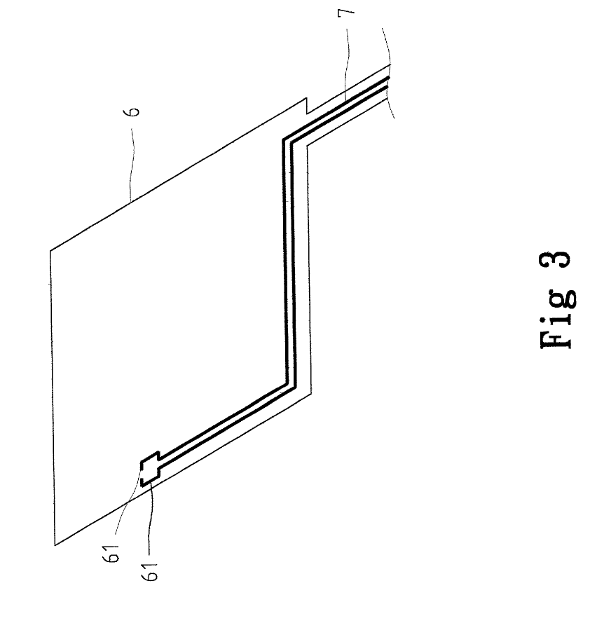

a. As refer to FIG. 3, the printing of the silver paste circuit, superior light guiding diffusion plate (6) [symbol] silver painting material are preferable when applying to present invention. The diffusion plate (6) film is adopted and silver paste circuit is painted into when processing.

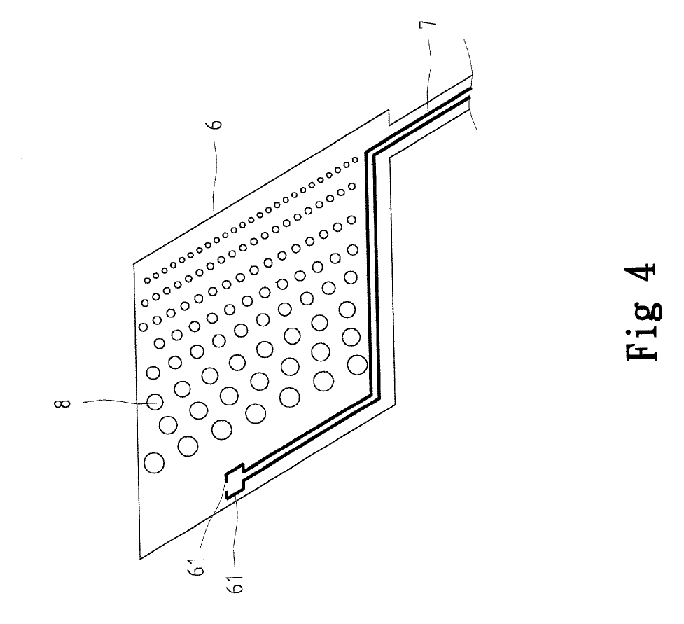

b. With reference to FIG. 4, light guide plate (6), the materials used are the product of the printed silver paste circuit (7) in the aforementioned step a) and the printing ink for light guiding. Screen printing (or laser engraving, etching and injection etc.) could be used as the method for producing the light guiding particles (8) or lines, and the design of the light guiding particles or lines will be different if the location where the chip is embedded changes.

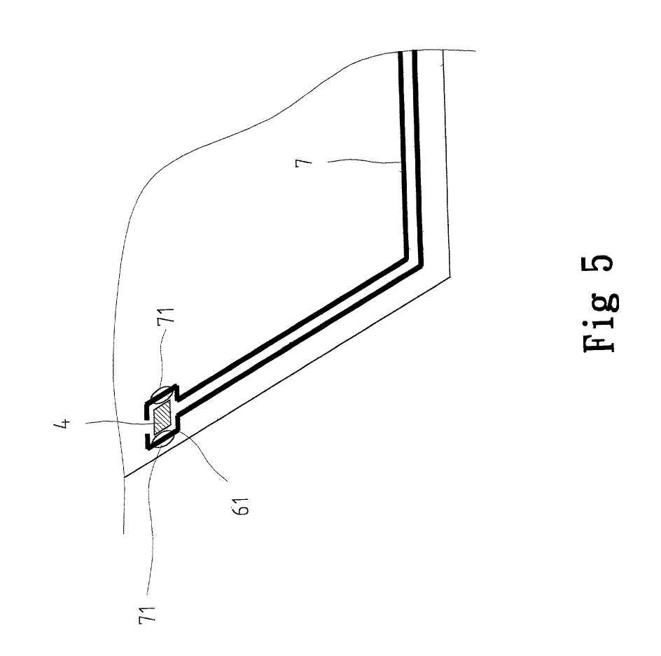

c. With reference to FIG. 5, the embedding of the ultraviolet emission chip, the materials used are the light guide plate (10) finished in the aforementioned step b) and the ultraviolet emission chip (4), and the silver ink (71) used for joint fixation is also included. Regarding the process, the ultraviolet emission chip (4) is embedded in the chip embedding site (61) of the light guide plate (10), then the diode (51) of the ultraviolet chip (4) is fixed by the silver ink (71) for joint fixation on the joint thereof, which connects the diode (51) of the ultraviolet emission chip (4) to the silver paste (7).

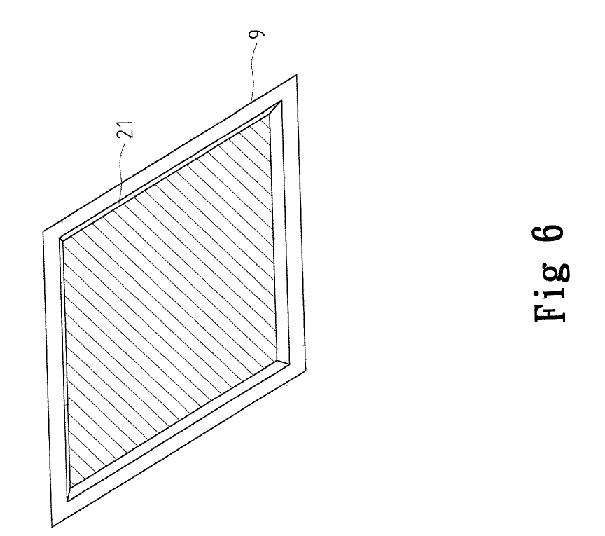

d. With reference to FIG. 6, the spreading of the resin coating comprising light absorptive pigment powder, the materials used are the PET thin film (9) of excellent light transmittancy and resin coating comprising light absorptive pigment. Regarding the process, given the PET thin film (9), a thick film of the resin coating lamina (21) is printed on the PET thin film (9) by screen printing or spreading wherein the resin coating comprising light absorptive pigment or ink is used. The thickness is considered to be between 70 μm and 250 μm.

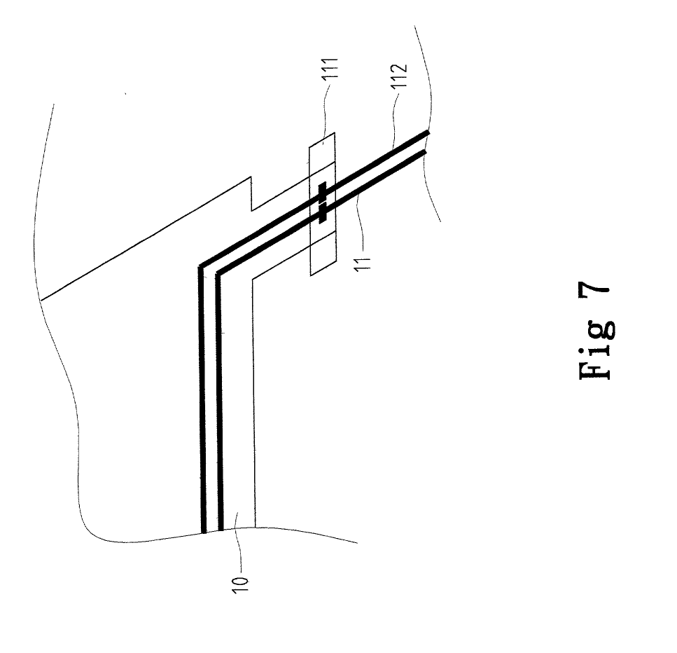

e. With reference to FIG. 7, the producing of the output PIN terminal, the materials used are the product (10) of the step c), the tin-plated copper terminal for the output PIN (112) and the adhesive film (111). Regarding the process, given the product (10) of the step c) at first, the terminal (112) is fixed on the adhesive film (111) with the hot press equipment, then the half-finished product is fixed on the output PIN terminal (11) of the ultraviolet emission chip (4) by hot press using the hot press equipment.

f. With respect to the adhesive combination of the reflective sheet (20), the light guide plate (10) and the light absorptive pigment resin lamina (21), the materials used are the light reflective sheet film (20) for the optoelectronical applications, the product {chip light guide plate (10)} of the step e), the product {light absorptive pigment resin lamina (21)} of the step d) and the glue or hot melt glue. Regarding the process given the light reflective sheet film (20) and product {chip light guide plate (10)} and {light absorptive pigment resin lamina (21)} of the steps d) and e), screen printing or coating of the glue or hot melt glue is performed on the sites to be adhered, and the three layers are adhered to become a whole one by hot press in the order that the light reflective sheet film (20) is the lower, the {chip light guide plate (10)}is the middle, and {light absorptive pigment resin lamina (21)} is the upper.

g. The completion of the flat illuminant module: The light absorptive polymer particle is the type with a suitable size which is an inorganic compound multiple supported by inorganics, which absorbs the illuminant under lights and liberating it in the dark. The light absorptive polymer particle is able to absorb and liberate illuminant constantly at the same time, enhance conduct and glowing effects of the illuminant and keeps lame illuminant last longer.

Accordingly, illuminant absorption color powder (1) is mixed with plastic colophonium to form 3D container modeling or flat illuminant module. The preferred illuminant absorption color powder (1) allowed various joys in vision with a brighter, clearer and longer lasting illuminant.

Furthermore, there is no restriction in applying the present invention; it can also be used in many other ways. For example, apply the present invention to all kinds of plastic colophonium (e.g. decorative objects and key chains) will form an object that is able to absorb and liberate the illuminant; in other word, glow in the dark. Moreover, by applying the present invention to presswork, it will be any shape of interface of stationary (such as stickers), toys, gifts, or items with glass or china (shown in table 1). Hence to form the effects of glowing allows vision fantasy as in showing the present objects' beauty and unique style; here shows the difference of the ordinary illuminant absorption color powder made products, those products are rather simple and drab with the shortcomings of shorter illuminant liberating period. It is therefore the primary object of present invention to provide the above “long remaining lighting source transforming wavelength”

Accordingly, various color choices of illuminant absorption color powder (1) can be used when painting or spraying through the presswork in order to allow a vision fantasy as in showing the present objects' beauty and unique style. Therefore, the present invention will be fitting customers' needs in terms of its unique style and also industrial needs in terms of its impressive innovation.

What is claimed is:

1. “The long remaining illuminant source transforming wavelength”. The invention is presented in the form of container modeling, which is made from plastic colophonium and illuminant absorption color powder with a build-in InGaN ultraviolet remission chip that contains DC power source connection. The illuminant absorption units made of illuminant absorption color powder and plastic colophonium, connecting to the power source with the build-in InGaN ultraviolet remission chip enable the color powder within the container to absorb and liberate the illuminant constantly, hence to deliver a brighter, clearer and long lasting lame illuminant.

2. “Long remaining illuminant source transforming wavelength” as claimed in claim 1, wherein the illuminant absorption color powder is mixed equally with transparent or semitransparent colophonium to form the material of the container.

3. “Long remaining illuminant source transforming wavelength” as claimed in claim 1, wherein the illuminant absorption color powder is mix equally with transparent or semitransparent colophonium, which can then be transferred through presswork, printing and spraying as the interface materials for all kids of finished goods

4. “Long remaining illuminant source transforming wavelength” as claimed in claim 1, wherein the plastic colophonium is either transparent or semitransparent, which is able to mix with other resins, for example epoxy resin, acrylic resin and silica gel.

5. “Long remaining illuminant source transforming wavelength” as claimed in claim 1, wherein the illuminant source could apply on flat shape, includes the steps of the printing of the silver paste circuit, the producing of light guide plate, the embedding of ultraviolet emission chip, the spreading of the resin coating comprising light absorptive pigment powder, the producing of the output PIN terminal, the adhesive combination of the reflective sheet, the light guide plate with chip and light absorptive pigment resin film layer, and then the completion of the flat illuminant module.
